(19) United States
(12) Patent Application Publication
(10) Pub. No.: US 2010/0122997 A1
(43) Pub. Date: May 20, 2010

(54) Method of manufacturing irregular shapes of solder wires and product thereof

(76) Inventor: Ting-Pan Liu, Hsin Chuang City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/292,293

(22) Filed: Nov. 17, 2008

(51) Int. Cl. B23K 31/02; B23K 35/14

(52) U.S. Cl. 228/203; 228/56.3

(57) ABSTRACT

A method of manufacturing irregular shapes of solder wires comprising the steps of: (a) acquiring materials of solder wire; (b) placing the materials into wire manufacturing machines to form solder wires into specifically designed profiles; (c) transporting the resulted solder wires to forming equipment and tools to form solder wires into specific shapes. The invention also provides products made with above-mentioned methods of manufacturing irregular shapes of solder wires.

### BACKGROUND OF THE INVENTION

1. Field of the Invention

The present invention relates to a solder wire; in particular, to a method of manufacturing solder wires of specific forms and the product thereof.

2. Description of Related Art

Solder wires can be used to facilitate mechanical and electrical connections of two objects. For practical use in industry, it is done by manual solder operations, in which a user holds the solder wire on one hand, while the other hand holds an iron, conjunctively acting to use the iron to melt the solder wire and letting it be cured and fixed onto the target; or alternatively to first print the solder paste onto the surface of the target then use a solder oven to melt the solder paste, thereby achieving the objective of soldering. However, conventional soldering has the following disadvantages:
1. manual solder operations require extensive manpower, thus procrastinating processing speed and increasing costs in terms of wages and time;
2. workers of manual solder operations need to be professionally trained to provide adroit solder results;
3. if the object needs to be rotated to change its orientation and position during manual solder operations, it is inevitable to consume more solder time and manual operations, and sometimes even require the expenses of specifically made clamping tools, thus causing additional costs;
4. non-linear manual solder operations (such as curve-shaped, spline-shaped, multiple line segment connections or combinations of various line segments) usually require rotation of the object in order to change its orientation and position, which is an even more challenging task;
5. missing solder caused by human negligence, insufficient training or insufficient supply of solder wire may occur in manual solder operations;
6. fissures of missing solder may occasionally occur at places where the thickness of the applied solder layer is insufficient, which requires manual amendment, leading to higher costs in verification and reduce operations.

Accordingly, the inventors of the present invention having considered the above-mentioned improvable defects herein propose the present invention which can provide a reasonable design and effectively eliminate the aforementioned drawbacks.

### SUMMARY OF THE INVENTION

The objective of the present invention is to provide a method of manufacturing irregular shapes of solder wires and product thereof, thereby overcoming disadvantages found in conventional manual solder operations and solder paste printing, accordingly saving manpower and time, shortening manufacturing duration of time, enhancing process yield, reducing redo cost and ameliorating solder perspective aesthetics as well.

To achieve the aforementioned objective, the present invention provides a method of manufacturing irregular shapes of solder wires, comprising the following steps: acquiring materials necessary for soldering; placing the materials into wire manufacturing machines to form solder wires into specifically designed profiles; and transporting the resulted solder wires to forming equipment and tools to form the solder wires into specific shapes.

The present invention further provides a method of manufacturing irregular shapes of solder wires, comprising the following steps: acquiring the solder wires; and using forming equipment and tools to form the solder wires into specific shapes.

The present invention yet further provides a product of irregular shapes of solder wires manufactured by the aforementioned manufacturing method.

The present invention provides the following advantageous effects:
1. to save time in conventional manual soldering, thereby reducing manufacturing cost;
2. to shorten training duration required for conventional solder workers, thereby reducing training time and cost;
3. to enhance manufacturing yield, thus lowering missing solder defects in manual solder operations;
4. to improve the drawback of insufficient printing amount of solder paste;
5. to ameliorate perspective aesthetics of non-linear solder operations.

In order to allow further understanding of the characteristics and technical contents of the present invention, references are made to the following detailed descriptions and appended drawings; however, the appended drawings are simply illustrative and referential, rather than being used to limit the present invention thereto.

### BRIEF DESCRIPTION OF THE DRAWINGS

FIG. 1 shows a flowchart of the method of manufacturing irregular shapes of solder wires according to the present invention.

FIG. 2 shows a flowchart of an embodiment of the method of manufacturing irregular shapes of solder wires according to the present invention.

FIGS. 3 to 8 show a stereo diagram of the manufactured product of various irregular shapes of solder wires according to the present invention.

FIG. 9 shows a flowchart of the method of utilizing irregular shapes of solder wires according to the present invention.

FIG. 10 shows a flowchart of another method of utilizing irregular shapes of solder wires according to the present invention.

FIG. 11 shows a diagram of positioning design of the irregular shapes of solder wires according to the present invention.

FIG. 12 shows a diagram of another positioning design of the irregular shapes of solder wires according to the present invention.

FIG. 13 shows a diagram of solder stripping design of the irregular shapes of solder wires according to the present invention.

FIG. 14 shows a diagram of another solder stripping design of the irregular shapes of solder wires according to the present invention.

FIGS. 15A to 15E show diagrams of profile changes of the irregular shapes of solder wires according to the present invention.

### DETAILED DESCRIPTION OF PREFERRED EMBODIMENTS

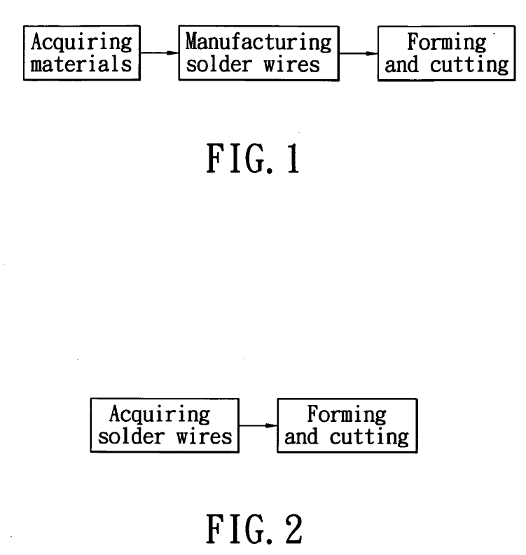

Referring now to FIG. 1, the present invention provides a method of manufacturing irregular shapes of solder wires, comprising the following steps:

STEP 1: acquiring soldering materials, which are raw materials for manufacturing solder wires, comprising tin alloys, soldering flux and the like;

STEP 2: using first an extruder to extrude the soldering materials, then using the wire manufacturing machine to form solder wires and add soldering flux, whereby the diameter and cross-section profile of the wires are not restricted but depend on the required amount of tin in the target; and

STEP 3: transporting the created solder wires directly to the forming equipment and tools, in which the forming equipment and tools may be an extruder, a line/wire winding machine, a line/wire manufacturing machine, general punch presses (e.g. conventional, pneumatic, pressure-boosted punch presses or other types of punch presses), slide forming punch presses, bending punch presses or pressure punch presses and so forth, and such forming equipment and tools are quipped with suitable forming molds and cutting tools to form the solder wires into the desirable specific shapes.

Referring now to FIG. 2, the present invention provides another method of manufacturing irregular shapes of solder wires, comprising the following steps:

STEP 1: acquiring conventional solder wires, in which the diameter and cross-section profile of the wires are not restricted but depending on the required amount of tin in the target; and

STEP 2: using manual tools like long nose pliers, or forming equipment and tools such as a line/wire manufacturing machine, a line/wire winding machine, general punch presses (e.g. conventional, pneumatic, pressure-boosted punch presses or other types of punch presses), slide forming punch presses, bending punch presses or pressure punch presses and so forth, in which such forming equipment and tools are quipped with suitable forming molds and cutting tools to form the resulted solder wires into the desirable specific shapes.

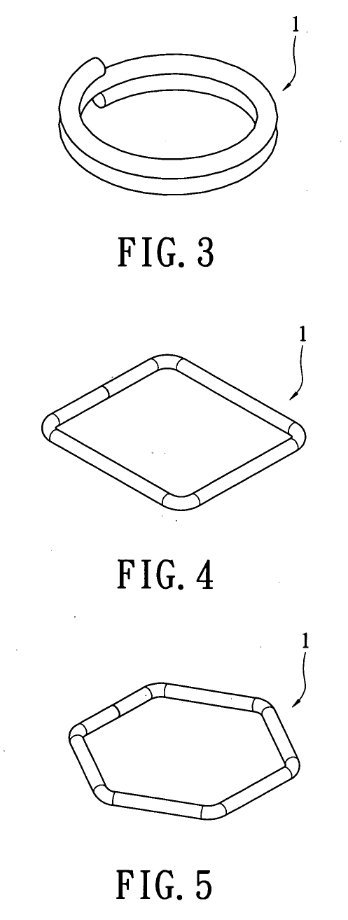

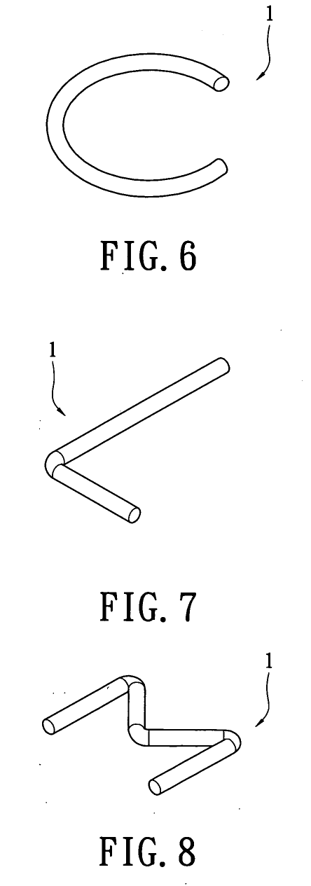

Referring now to FIG. 3 to 8, the irregular shapes of solder wires 1 with desirable specific shapes can be manufactured by means of the above-mentioned manufacturing methods, and the shapes of the irregular shapes of solder wires 1 are not limited. The irregular shapes of solder wires 1 can be a single loop, including circular, square, triangular, pentagonal, hexagonal, star-shaped or other specific shapes; such a single-looped design is suitable for general solder wires.

The irregular shapes of solder wires 1 may be also multi-looped, including circular, square, triangular, pentagonal, hexagonal, star-shaped or other specific shapes; such a multi-looped design is suitable for solder wires requiring higher amount of tin.

The irregular shapes of solder wires 1 may be open-looped or of other shapes as well, including C-shaped, J-shaped, L-shaped, M-shaped, N-shaped, S-shaped, U-shaped, V-shaped, W-shaped, Z-shaped, straight or of other specific shapes; such an open-looped design is suitable for solder wire targets inapplicable for the loop-based solder wires illustrated as above;

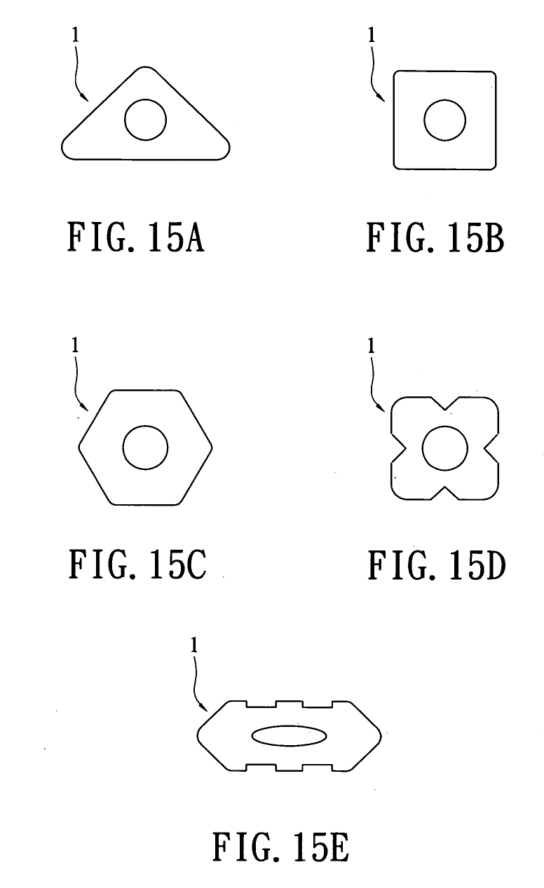

As shown in FIGS. 15A to 15E, it is possible to enhance rigidness of solder wires during wire manufacturing, to change their profile during conventional solder wire manufacturing and to add post-processes in conventional solder wire manufacturing for modifying the profile of the irregular shapes of solder wires 1 of the present invention, thereby increasing their rigidness.

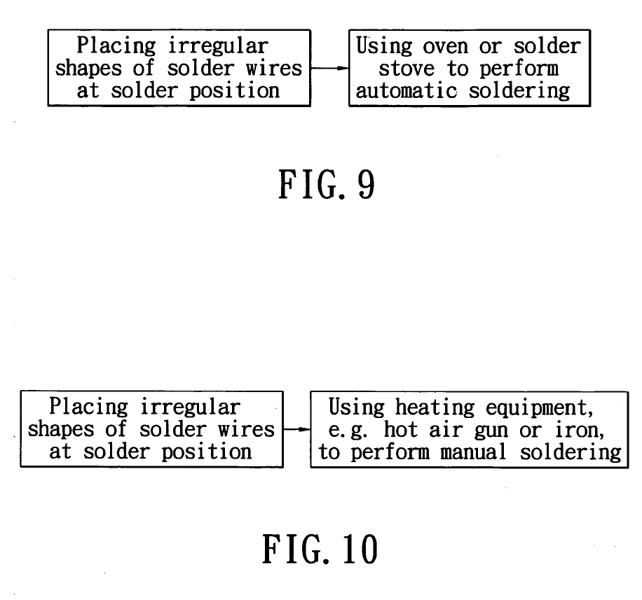

Referring now to FIG. 9, the method of utilizing irregular shapes of solder wires according to the present invention comprises the following steps:

STEP 1: placing the irregular shapes of solder wires at the solder position;

STEP 2: using an oven or solder stove to heat the irregular shapes of solder wires, allowing the irregular shapes of solder wires to melt and fixed at the solder position, thereby achieving automatic solder operations.

Referring now to FIG. 10, another method of utilizing irregular shapes of solder wires according to the present invention comprises the following steps:

STEP 1: placing the irregular shapes of solder wires at the solder position;

STEP 2: using the heating equipment such as hot air gun or iron to heat the irregular shapes of solder wires, allowing the irregular shapes of solder wires to melt and fix at the solder position, thereby achieving manual solder operations.

The present invention has the following features:

1. the solder wires used in solder operations are formed into specific shapes, rather than the approaches found in convention manual solder or solder paste printing;

2. mass production: after placement of the aforementioned irregular shapes of solder wires at the solder position, by allowing the target to pass through the heating equipment (such as a solder stove or oven), it is possible to achieve mass production;

3. manual solder operations: after placement of the aforementioned irregular shapes of solder wires at the solder position, instead of using the heating equipment (such as a solder stove or oven), the solder operations are accomplished by hand-held heating tools (such as a hot air gun or iron etc.), thereby also accelerating the solder speed to be faster than conventional ways;

4. adjustment of rigidness: for low rigidness in solder wires, in manufacturing irregular shapes of solder wires, it can be optionally increased by changing the cross-section profile during manufacturing, or by tooling operations such as punching, pressing or flattening;

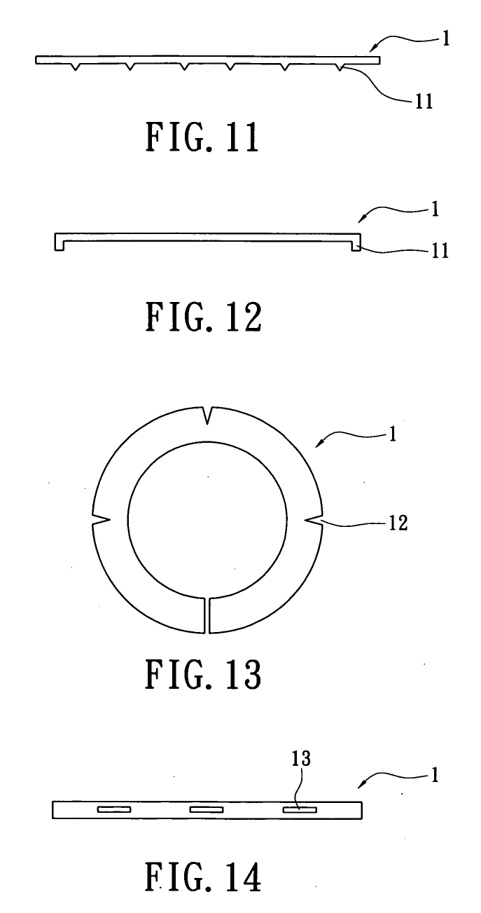

5. positioning design: it is possible to mark curved, bumped or recessed positioning positions 11 by punching, pressing or bending (as shown in FIGS. 11 and 12), in which the positioning point 11 shown in FIG. 11 is bumped and the positioning point 11 shown in FIG. 12 is bent. Thus in placing the irregular shapes of solder wires at the solder position, it is more convenient to be accomplished, and airflow interference from the heating equipment can be reduced as well, so as to enhance performance and tooling yield. Similarly, when applying the position design, there should be configured with counterpart design on the target, such as square holes, round holes, recessed holes or bumped holes and the like.

6. increased amount of tin: by using the straight irregular shapes of solder wires with positioning design, it is possible to provide increased amount of tin, allowing to eliminate the drawback of insufficient amount of tin in solder paste, thereby reducing manual supplementary solder checks and reduce cost.

7. tin-stripping design: since the soldering flux of solder wife is contained in the core of solder wire, in order to more rapidly provide effects when performing massive heating solder operations or using hand-held heating equipment, during the formation of irregular shapes of solder wires, it is possible to add tin-stripping design in the forming mold, such as fabricating notches 12 (as shown in FIG. 12) at different positions in the irregular shapes of solder wires, or linear holes 13 at different position in the irregular shapes of solder wires to allow the soldering flux to flow out, or alternatively the apertures (not shown), facilitating the soldering flux to be faster heated and to flow out to achieve the effect of solder enhancement, and also providing more uniform distribution of melted tin.

8. flow control: instead of controlling melted tin by dragging solder materials with the iron found in conventional solder operations, by using the irregular shapes of solder wires, it is possible to employ the placement carrier passing through the oven to prescribe the flow direction of melted tin, enabling distribution of melted tin to prescribed positions.

The aforementioned descriptions simply set forth the preferred embodiments of the present invention, rather than intending to limit the scope of the present invention thereto. It is noted that all effectively equivalent changes made based on the present disclosure and appended drawings thereof are reasonably deemed to be encompassed by the range of legal protection delineated in the subsequent claims.

1. A method of manufacturing irregular shapes of solder wires, comprising the following steps:
acquiring materials necessary for soldering;
placing the materials into wire manufacturing machines to form solder wires into specifically designed profiles; and
transporting the created solder wires to forming equipment and tools to form the solder wires into specific shapes.

2. The method of manufacturing irregular shapes of solder wires according to claim 1, wherein the materials consist of a tin alloy and soldering flux.

3. The method of manufacturing irregular shapes of solder wires according to claim 1, wherein the forming equipment and tools include an extruder, a line/wire manufacturing machine, a line/wire winding machine, a punch press, a bending punch press or a pressure punch press.

4. The method of manufacturing irregular shapes of solder wires according to claim 1, wherein the forming equipment is equipped with forming molds and cutting tools.

5. The method of manufacturing irregular shapes of solder wires according to claim 1, wherein on the solder wires of specific shape comprise positioning points.

6. The method of manufacturing irregular shapes of solder wires according to claim 5, wherein the positioning points are made by punching, pressing or bending.

7. The method of manufacturing irregular shapes of solder wires according to claim 1, wherein on the solder wires of specific shape comprise notches, apertures or linear holes.

8. The method of manufacturing irregular shapes of solder wires according to claim 1, wherein the solder wires of specific shape change cross-section profile upon wire manufacturing, or upon application of punching, pressing or flattening in the tooling process, so as to increase their rigidness.

9. A product of irregular shapes of solder wires manufactured by the method of manufacturing irregular shapes of solder wires according to claim 1.

10. The product of irregular shapes of solder wires according to claim 9, wherein the irregular shapes of solder wires are single-looped, multi-looped or open-looped.

11. The product of irregular shapes of solder wires according to claim 9, wherein the irregular shapes of solder wires are circular, square, triangular, pentagonal, hexagonal, star-shaped, C-shaped, J-shaped, L-shaped, M-shaped, N-shaped, S-shaped, U-shaped, V-shaped, W-shaped, Z-shaped or straight.

12. A method of manufacturing irregular shapes of solder wires, comprising the following steps:
acquiring solder wires; and using forming equipment and tools to deform the solder wires by bending the solder wires into specific geometric shapes defining solder with profile corresponding to predetermined solder target profile area for reducing the time of soldering and for providing a uniform soldering to said target.

13. The method of manufacturing irregular shapes of solder wires according to claim 12, wherein the solder wires consist of a tin alloy and soldering flux.

14. The method of manufacturing irregular shapes of solder wires according to claim 12, wherein the forming equipment and tools include a hand tool, a line/wire manufacturing machine, a line/wire winding machine, a punch press, a bending punch press or a pressure punch press.

15. The method of manufacturing irregular shapes of solder wires according to claim 12, wherein the forming equipment is equipped with forming molds and cutting tools.

16. The method of manufacturing irregular shapes of solder wires according to claim 12, wherein the solder wires of specific shape comprise positioning points thereon.

17. The method of manufacturing irregular shapes of solder wires according to claim 16, wherein the positioning points are made by punching, pressing or bending.

18. The method of manufacturing irregular shapes of solder wires according to claim 12, wherein the solder wires of specific shape comprise notches, apertures or linear holes.

19. The method of manufacturing irregular shapes of solder wires according to claim 12, wherein the solder wires of specific shape change cross-section profile upon application of punching, pressing or flattening in the tooling process, so as to increase their rigidness.

20. A product of irregular shapes of solder wires manufactured by the method of manufacturing irregular shapes of solder wires according to claim 12.

21. The product of irregular shapes of solder wires according to claim 20, wherein the irregular shapes of solder wires are single-looped, multi-looped or open-looped.

22. The product of irregular shapes of solder wires according to claim 20, wherein the irregular shapes of solder wires are circular, square, triangular, pentagonal, hexagonal, star-shaped, C-shaped, J-shaped, L-shaped, M-shaped, N-shaped, S-shaped, U-shaped, V-shaped, W-shaped, Z-shaped or straight.

23. The method of manufacturing irregular shapes of solder wires according to claim 12, wherein the solder wires are bended to single-looped geometric shapes, multi-looped geometric shapes or open-looped geometric shapes.

24. The method of manufacturing irregular shapes of solder wires according to claim 12, wherein the solder wires are bended to circular, square, triangular, pentagonal, hexagonal, star-shaped, C-shaped, J-shaped, L-shaped, M-shaped, N-shaped, S-shaped, U-shaped, V-shaped, W-shaped, or Z-shaped.
